(19) United States
(12) Patent Application Publication
(10) Pub. No.: US 2017/0203926 A1
(43) Pub. Date: Jul. 20, 2017

(54) VIBRATING TROUGH AND VIBRATORY CONVEYING DEVICE FOR TRANSPORTING SHINGLED PRODUCTS IN FOOD PRODUCTION

(71) Applicant: Robert Bosch GmbH, Stuttgart (DE)

(72) Inventors: Markus Landolt, Hallau (CH); Peter Blanz, Neuhausen (CH)

(21) Appl. No.: 15/326,582

(22) PCT Filed: Jun. 26, 2015
(86) PCT No.: PCT/EP2015/064594

§ 371 Date: Jan. 16, 2017

(30) Foreign Application Priority Data
Jul. 14, 2014 (DE) 10 2014 213 639.3

(51) Int. Cl. B65G 27/04; B65B 23/12; B65B 37/04; A21C 15/00

(52) U.S. Cl. CPC B65G 27/04; A21C 15/00; B65B 23/12; B65B 37/04; B65G 2201/0205

(57) ABSTRACT

The present invention relates to a vibrating trough (1) for transporting shingled products (2) in food production comprising a transport surface (3) which is designed to carry the products (2) and is excited to vibrate in order to transport the products (2) along the transport surface (3) from a starting point (A) to an end point (E) of the transport surface (3), wherein the transport surface (3) has wedge-shaped sections (4) which are arranged on a base area (5) of the vibrating trough (1), wherein the wedge-shaped sections (4) each have an ascending region on a side oriented toward the starting point (A) via which the products (2) are lifted with respect to the base area (5) during transport, and a dropping-off region (4b) on a side oriented toward the end point (E) at which the products (2) drop back during transport to a lower lying point on the transport surface (3).

### BACKGROUND OF THE INVENTION

The present invention relates to a vibrating trough for transporting shingled products in food production.

In food production, products, in particular baked goods such as, for example, biscuits, are taken from the oven or cooling conveyor lying flat and are supplied in a shingled or layered manner in multiple lanes by way of belts and chutes to a vibrating trough. Such a vibrating trough serves as a transporting and storing section and moves the transport segment, for example, to a portioner or creamer. If gaps occur in the product supply, a break is generated in the segment. Round products in vibrating troughs with a round cross section automatically re-connect after a segment break. In the case of rectangular products, but also in the case of products with a different basic form, the connection has to be made manually, which causes high costs and is prone to error.

Vibrating troughs are used today for variously shaped products with minimum changeover, however with the disadvantages previously described.

DE102006045020A1 shows a conveyor structure which includes several vibrating troughs which are arranged in a row and are arranged to as to be pivotable in order to enable a product to be conveyed by the conveyor structure. The individual vibrating troughs, in this case, each comprise a surface which extends horizontally in a longitudinal direction.

### SUMMARY OF THE INVENTION

The vibrating trough according to the invention for transporting shingled products, in particular in food production, includes a transporting surface which is set up to carry the products and to be activated to produce a vibration in order to transport the products along the transporting surface from a starting point to an end point of the transporting surface, wherein the transporting surface comprises wedge-shaped portions which are arranged on a floor area of the vibrating trough, wherein the wedge-shaped portions comprise in each case an ascending region on a side oriented toward the starting point, by means of which the products are raised in relation to the floor area during transport, and a descending region on a side oriented toward the end point, at which the products fall back onto a lower-lying point of the transporting surface during transport. In this case, the floor area can either be present on a structural component or can be a virtual reference plane.

This is advantageous as, when a break in a segment occurs, such a vibrating trough, as a result of the wedge-shaped portions, enables automatic segment connection of a transport segment of shingled products. After a gap in the transport segment, the product is actively raised by way of said wedge-shaped portion and falls reliably onto the preceding product of the transport segment. Active raising, in this case, means that the product is raised in relation to the floor area as a result of its movement over one of the wedge-shaped portions. As a result of the pressure of the products as they catch up, the rear product in the transport segment experiences a greater speed than the product which has passed the shoulder directly beforehand as said product does not experience any dynamic pressure. As a result, a gap between said products is decreased in size and closed. Gaps in the transport segment, in particular in the case of rectangular or square products, no longer have to be closed manually. As a result, the number of necessary operators can be reduced and consequently more cost-efficient production achieved. In addition, disruptions in a production chain which are caused by a break in the transport segment are reduced when a vibrating trough according to the invention is used. In this case, a high level of reliability is achieved with low costs as it is not necessary to install an additional sensor system. As the vibrating trough enables automatic segment connection irrespective of the form of the product, it does not have to be changed when the form of the product is changed, as a result of which a format changeover time is reduced.

It is advantageous when the wedge-shaped portions are formed by several overlapping individual elements. This is advantageous as consequently a maximum height of the wedge-shaped portions is able to be adapted in a simple manner to the product to be transported.

It is equally advantageous when the wedge-shaped portions connect directly to one another. Consequently, the vibrating trough can include a maximum number of wedge-shaped portions and gaps in the transport segment are closed after a minimum distance.

In addition, it is advantageous when a spacing between two descending regions of two wedge-shaped portions following one after another in the direction of transport is chosen in dependence on the length of the product and is produced in particular by multiplying the length of the product by a factor of between 1 and 20. In a preferred manner, the factor is between 2 and 5. Gaps are closed in a particularly efficient manner as a result of said spacings.

It is equally advantageous when a spacing between two descending regions of two wedge-shaped portions following one after another in the direction of transport is within a range of between 100 mm and 1000 mm. In this case, a range of between 200 mm and 400 mm is preferred. Gaps are closed in a particularly efficient manner as a result of said spacings.

In particular, the products fall back in the direction of the floor area at the descending region during transport. As a result, transport is possible along the floor area irrespective of the maximum height of the wedge-shaped portions.

In addition, it is advantageous when, on at least one side, in particular on both sides, the transporting surface comprises a guide which is located laterally in relation to a direction of transport. As a result, the product is prevented from falling from the vibrating trough during transport.

Furthermore, it is advantageous when the transporting surface and the laterally located guide are formed by a one-piece element, preferably a sheet metal element. A number of connecting elements which can fail when the vibrating trough vibrates is consequently minimized. The reliability of the vibrating trough is consequently increased.

It is equally advantageous when the wedge-shaped portions comprise a maximum height which is greater than or equal to a height of the product to be transported when said product is located on the transporting surface. This ensures that two consecutive products do not collide with one another in the transport segment but are laid in a shingled manner, that is to say partially overlapping one another, in order to close the transport segment.

In addition, it is advantageous when an angle between the floor area and the ascending region of two wedge-shaped portions increases between two wedge-shaped portions following one after another in the direction of transport. As a result, it is easier for a product to catch up a preceding product in the transport segment as transport in the portion of the vibrating trough located in the direction of transport is slower and as a result gaps are closed more quickly. In addition, it is consequently possible to use fewer wedge-shaped portions, as a result of which a length of the vibrating trough is able to be shortened. It is also consequently possible to close larger gaps, which in turn increases process reliability in a production chain using a vibratory conveying device according to the invention.

It is also advantageous when the floor area forms a plane since, as a result, particularly uniform transport is made possible.

It is also advantageous when a rear portion of the floor area located on the side of the end point is raised in relation to its initial development in the direction of the transporting surface. In this case, it is in particular advantageous when the floor area is formed from two planes which form an obtuse angle with respect to one another. As a result, it is easier for a product to catch up a preceding product in the transport segment as transport in such an ascendingly inclined portion of the vibrating trough is slower and as a result gaps are closed more quickly. In addition, it is consequently possible to use fewer wedge-shaped portions, as a result of which a length of the vibrating trough is able to be shortened. It is also consequently possible to close larger gaps, which in turn increases process reliability in a production chain using a vibratory conveying device according to the invention.

It is equally advantageous when the vibrating trough is arranged in such a manner in a vibratory conveying device that during an operation of the vibratory conveying device, the starting point of the transporting surface is located higher than the end point of the transporting surface or the starting point of the transporting surface is located lower than the end point of the transporting surface. Consequently, a transporting speed for the product is increased or a height difference is able to be overcome, the products being prevented from slipping backward.

It is also advantageous when the vibrating trough is arranged in such a manner in a vibratory conveying device that during an operation of the vibratory conveying device, the starting point of the transporting surface is located at the same height as the end point of the transporting surface. Consequently, as direct as possible a connection between two production units is created which nevertheless enables segment connection in the case of shingled products.

It is also advantageous when the transporting surface of the vibrating trough is inclined laterally in the direction of transport during an operation of the vibratory conveying device. In this case it is particularly advantageous when the vibrating trough is inclined in the direction of the lateral guide during an operation of the vibratory conveying device. As a result, the products are able to be aligned uniformly with respect to one another.

In addition, the invention relates to a vibratory conveying device having a vibrating trough according to the invention.

### BRIEF DESCRIPTION OF THE DRAWINGS

Exemplary embodiments of the invention are described in detail below with reference to the accompanying drawing. Identical or functionally-identical parts, in this case, are designated with the same references. The drawing is as follows:

FIG. 1 shows a schematic representation of a first embodiment of a vibrating trough according to the invention for transporting shingled products,

FIG. 2 shows a representation comparing a first embodiment of a vibrating trough according to the invention for transporting shingled products with a second embodiment of a vibrating trough according to the invention for transporting shingled products,

FIG. 3 shows a schematic representation of a third embodiment of a vibrating trough according to the invention for transporting shingled products,

FIG. 4 shows a schematic representation of a fourth embodiment of a vibrating trough according to the invention for transporting shingled products,

FIG. 5 shows a first view of a schematic representation of a fifth embodiment of a vibrating trough according to the invention for transporting shingled products, said vibrating trough being arranged in a vibratory conveying device,

FIG. 6 shows a second view of a schematic representation of a vibrating trough according to the invention of FIG. 5, said vibrating trough being arranged in a vibratory conveying device, and

FIG. 7 shows a schematic representation of a sixth embodiment of a vibrating trough according to the invention for transporting shingled products, said vibrating trough being arranged in a vibratory conveying device.

### DETAILED DESCRIPTION

The vibrating trough 1 according to the invention is a vibrating trough for transporting shingled products 2 in food production. The vibrating trough 1 is produced for this purpose, among other things, in a preferred manner from food-grade materials. The shingled products 2 are products which, within their production or packing process, are transported by means of the vibrating trough 1 in a transport segment, each product 2 resting partially on a preceding product 2 in the transport segment, or at least should be resting on said preceding product were a segment break, which is to be corrected by the vibrating trough 1, not to have occurred. If products 2 are continuously supplied to the vibrating trough 1, they form a transport segment.

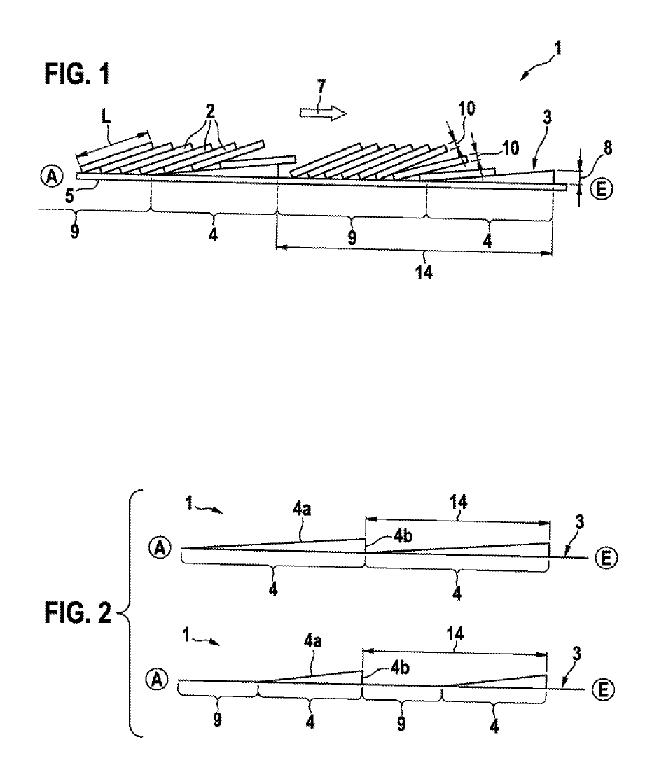

FIG. 1 shows a schematic representation of a first embodiment of a vibrating trough 1 for transporting shingled products 2. In said first embodiment, the vibrating trough 1 is formed by wedge-shaped portions 4 and level portions 9 which alternate with one another along a direction of transport 7. The direction of transport 7, in this case, is a direction in which the products 2 are transported from a starting point A of the vibrating trough 1 to an end point E of the vibrating trough 1. In this case, the starting point A is the outermost point of the vibrating trough 1 on a side along which the products 2 are supplied to the vibrating trough and the end point E is the outermost point of the vibrating trough 1 on a side along which the products 2 fall from the vibrating trough.

The wedge-shaped portions 4 are formed, for example, by wedge-shaped elements which are arranged spaced apart from one another in the direction of transport 7 on a level metal sheet. Part regions of the level metal sheet, which are located between the wedge-shaped elements, form the level portions 9. In an alternative embodiment, the wedge-shaped portions 4 are formed by deforming the level metal sheet. Such deformation and consequently the wedge-shaped portions 4 could, for example, be pressed into the level metal sheet. As a result, the vibrating trough is able to be provided as a one-part component.

The top surface of the level portions 9 and of the wedge-shaped portions 4 forms a transporting surface 3. This is set up for the purpose of carrying the products 2 and to be activated to produce a vibration in order to transport the products 2 along the transporting surface 3 from a starting point A to an end point E of the transporting surface 3. The shingled products 2 shown in FIG. 1 are rectangular biscuits shown in side view. The transporting surface 3 is activated to produce a vibration when the entire vibrating trough 1, for example by means of a vibrating motor, is made to vibrate. To this end, the vibrating trough 1 is arranged in a vibratory conveying device which includes a corresponding vibrating motor or another device that generates vibrations.

The wedge-shaped portions 4 of the transporting surface 3 are arranged on a floor area 5 of the vibrating trough 1. The floor area 5 of the vibrating trough 1 corresponds, in said first embodiment, to a plane in which the level portions 9 are also located. The floor area 5, in this case, is simply a reference plane, by means of which the arrangement of the wedge-shaped portions 4 is defined and is not an additional structural element.

The wedge-shaped portions 4 each include an ascending region 4a and a descending region 4b. The ascending region 4a, in this case, is located on a side of a wedge-shaped portion 4 that is oriented toward the starting point A. The products 2 are raised in relation to the floor area 5 during transport in the direction of transport 7 when they are moved over the ascending region 4a of the wedge-shaped portions 4. The descending region 4b, in this case, is located on a side of a wedge-shaped portion 4 that is oriented toward the end point E. The products 2 fall back onto a lower-lying point of the transporting surface 3 during transport in the direction of transport 7 when they reach a descending region 4b of a wedge-shaped portion 4.

In said first embodiment, the products fall back onto one of the level portions 9 and consequently onto the floor area 5. In this case, care must be taken to ensure that a product 2 which falls back onto a lower-lying point of the transporting surface 3 is able to fall onto a preceding product in the transport segment where shingled products 2 are transported. As a result, gaps in the transport segment can be closed as the product 2 falls onto the preceding product 2 even when said products do not lie on top of one another prior to the descending region 4b, that is to say were not shingled. In the case of large gaps, a product will not fall onto the preceding product immediately when passing a first wedge-shaped portion 4, but possibly only when several wedge-shaped portions 4 have been passed.

The spacing 14 between two descending regions 4b of two wedge-shaped portions 4 following one after another in the direction of transport is within a range of between 100 and 1000 mm, in a preferred manner between 200 and 400 mm. The spacing depends on the length L of the product 2 in the direction of transport when said product is situated on the transporting surface 3. The spacing 14 can also be determined from a function of the length L of the product 2. Thus, the spacing is chosen in a preferred manner within a range of between 1*L and 20*L, in a preferred manner between 2*L and 5*L.

The wedge-shaped portions 4 comprise a maximum height 8 which is greater than or equal to a product height 10 of the product 2 to be transported when said product is located on the transporting surface 3. The maximum height 8 corresponds in said first embodiment to a direct spacing between the floor area 5 and an apex of the wedge-shaped portions 4 at which the ascending region 4a and the descending region 4b adjoin one another. The product height 10 corresponds to a height of the product 2 when said product is located on the transporting surface 3 without resting on another product 2.

FIG. 2 shows a representation comparing a first embodiment of a vibrating trough 1 for transporting shingled products with a second embodiment of a vibrating trough for transporting shingled products. In this case, the first embodiment of the vibrating trough 1 is shown at the bottom and the second embodiment of the vibrating trough 1 is shown at the top. The second embodiment corresponds substantially to the first embodiment, however the wedge-shaped portions 4 connect directly to one another. This is achieved by omitting the level portions 9. It can be seen that consequently the descending region 4b of an arbitrary wedge-shaped portion 4 connects directly to the ascending region 4a of a wedge-shaped portion 4 following it in the direction of transport 7.

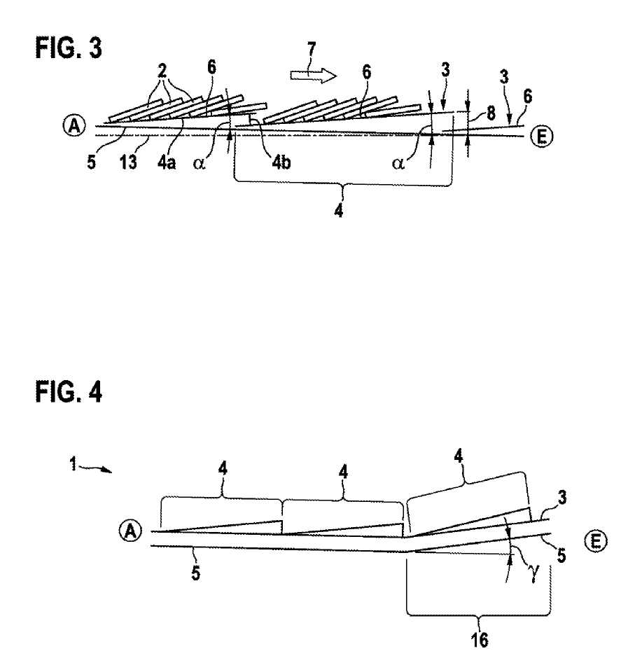

FIG. 3 shows a schematic representation of a third embodiment of a vibrating trough 1 according to the invention for transporting shingled products 2. The third embodiment corresponds substantially to the first or second embodiment, but the wedge-shaped portions 4 of a single vibrating trough 1 are formed by several individual elements 6 which overlap one another. Each individual element 6, in said embodiment, is formed from a level metal sheet. Each of the individual elements 6 is arranged at an angle a in relation to the floor area 5. The surfaces of the individual elements 6, in this case, are parallel to one another, however the individual elements 6 are displaced toward one another in the direction of transport in such a manner that a side of an individual element 6 that is oriented toward the starting point A lies under a side of an individual element 6 that is oriented toward the end point E following in the direction of transport 7. The surfaces of all the individual elements 6 form the transporting surface 3. In this case, each individual element 6 forms the ascending region 4a of each wedge-shaped portion 4. In alternative embodiments, the individual elements 6 can be expanded by a portion which is parallel to the floor area 5.

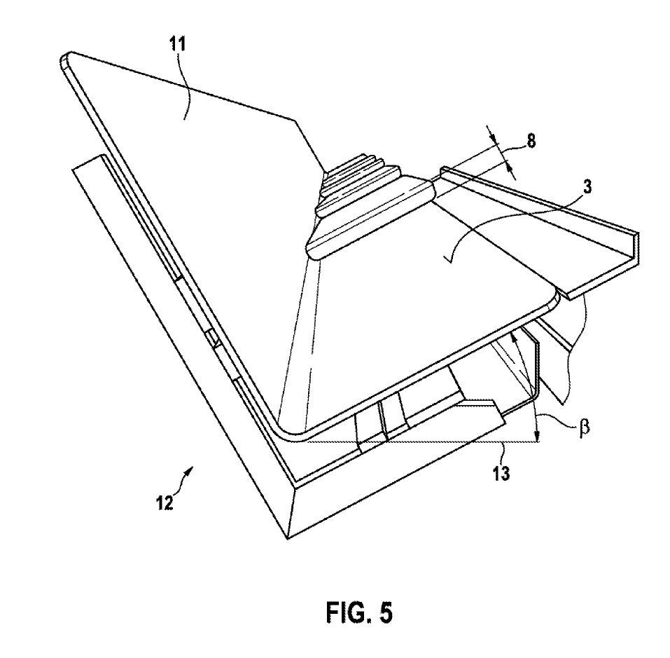

FIG. 4 shows a schematic representation of a fourth embodiment of a vibrating trough 1 according to the invention for transporting shingled products 2. The fourth embodiment corresponds substantially to the first to third embodiment, however a rear portion 16 of the floor area 5 that is located on the side of the end point E is raised in the direction of the transporting surface 3 in relation to its initial development. In the fourth embodiment shown, the floor area 5 is formed for this purpose from two planes which are at an angle γ with respect to one another. A kink is produced in the vibrating trough. In alternative embodiments, the floor area can also be raised in another manner. For example, the floor area 5 could be arched.

In an embodiment that is not shown in the figures, the angle α between the floor area 5 and the ascending region 4a of two wedge-shaped portions 4 increases between two wedge-shaped portions 4 following one another in the direction of transport. To this end, for example, the angle α is chosen as an angle of 1° degree for a first wedge-shaped portion 4 that is located in the direction of the starting point A. For a last wedge-shaped portion 4 that is located in the direction of the end point E, the angle α is chosen as an angle of 5° degrees. The wedge-shaped portions 4 located in between have an angle α which, in the direction of transport 7, is between 1° degree and 5° degrees, for example ascending in each case by one degree. Consequently, products 2 on a side of the vibrating trough 1 that is located in the direction of the end point E are transported slower than on a side of the vibrating trough 1 that is located in the direction of the starting point A since the transporting speed is reduced as an angle α of the ascending regions 4a increases. Consequently, gaps in the transport segment are reduced and closed in a quicker manner.

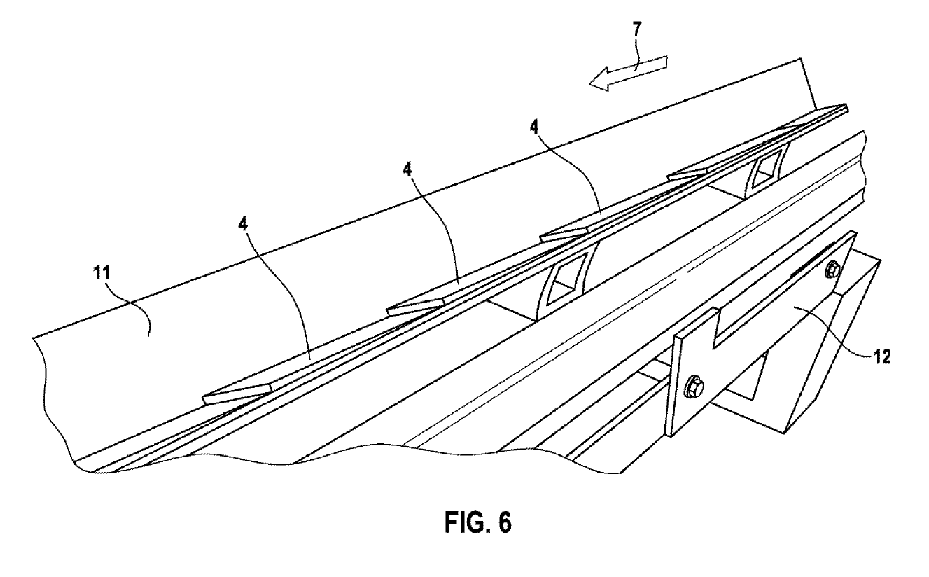

FIG. 5 and FIG. 6 show a schematic representation of a fifth embodiment of a vibrating trough 1 according to the invention for transporting shingled products 2. The fifth embodiment corresponds substantially to the second embodiment, but, in said embodiment, the transporting surface 3 comprises a first guide 11 that is located laterally in relation to the direction of transport 7 on at least one side. Even if this is not shown in the figures, such a laterally located guide can also be arranged in the other embodiments.

The first laterally located guide 11 extends along the transporting surface 3 from the starting point A to the end point E. In this case, the first laterally located guide 11 essentially forms a right angle with the floor area 5. The first laterally located guide 11 and the transporting surface 3 are formed by a one-piece element. This is achieved in said fourth embodiment as a result of correspondingly reshaping a metal sheet, here by bending it at right angles, said metal sheet also forming the level portions 9. In the previously described embodiments, the first laterally located guide 11 could, however, also be formed, for example, as a separate component or integrally on the transporting surface 3. Thus, the first laterally located guide 11 could, for example, be welded to the transporting surface 3.

The vibrating trough 1 described in the previously indicated embodiments is set up for the purpose of being arranged in a vibratory conveying device 12. Such an arrangement is shown in FIGS. 5 and 6. In this case, the vibrating trough 1 shown comprises the previously described advantageous first laterally located guide 11. The vibrating trough and consequently the transporting surface 3 of the vibrating trough 1 is arranged in such a manner in the vibratory conveying device 12 that it is inclined by an angle β from a horizontal 13 in the direction of the first laterally located guide 11. The angle β is chosen from a range of between 1°-50° degrees. In a preferred manner, the angle β is between 10° - 40° degrees and in a particularly preferred manner is between 15° and 25° degrees. The vibrating trough 1 is usable for the most varied forms of products 2 (round, rectangular, square, etc.). On account of the inclination by the angle β, the products 2 (round products as well) are always oriented onto one side, the side which comprises the wedge-shaped portions 4. The transporting surface 3 is consequently inclined laterally by the angle β in the direction of transport 7 when the vibratory conveying device 12 is operating. The connection between the vibrating trough 1 and the rest of the components of the vibratory conveying device 12 is developed here in such a manner that said vibrating trough is able to be detached and closed in a simple manner. The vibrating trough 1 is made to vibrate by a vibrating motor which is not shown in FIGS. 5 and 6.

The vibrating trough 1 is arranged in such a manner in the vibratory conveying device 12 that the end point E of the transporting surface 3 is located lower than the starting point A of the transporting surface 3. The products 2 are consequently transported from a plane that is higher-lying in the vertical direction to a lower-lying plane. The vibrating trough 1 is consequently inclined in relation to a horizontal 13 in such a manner that the products 2 are transported downward, as a result of which the transporting is supported by gravity. The inclination of the vibrating trough 1 in relation to the horizontal 13, in this case in said embodiment, is at an angle of 2° degrees in relation to the horizontal 13.

In alternative embodiments the vibrating trough 1 is arranged in such a manner in the vibratory conveying device 12 that the end point E of the transporting surface 3 is located higher than the starting point A of the transporting surface 3. The products 2 are consequently transported from a plane that is located lower in the vertical direction to a higher-lying plane. In further alternative embodiment, the vibrating trough 1 is arranged in such a manner in the vibratory conveying device 12 that the floor area is not inclined, that is to say extends substantially horizontally.

So that, when a product 2 contacts a product 2 following in the transport segment, the products 2 are shingled in a clean manner, that means that products 2 following one another in each case rest securely partially one on top of another, the transporting surface 3 of the vibrating trough 1 is provided with wedge-shaped portions 4. As a result, after a gap in the transport segment the product 2 is actively raised on said wedge-shaped portion 4 and falls securely onto the preceding product 2 of the transport segment. As a result of the pressure of the products 2 that are catching up, the rear product 2 in the transport segment experiences a faster speed than the product 2 which has passed the wedge-shaped portion 4 directly beforehand as said product does not experience any dynamic pressure. As a result, a gap between said products 2 is reduced in size and closed. In this way, unwanted gaps, but also gaps between shingled product groups, can be closed such that the shingling is continuous. In addition, the wedge-shaped portions 4 homogenize the shingled arrangement over the transport section.

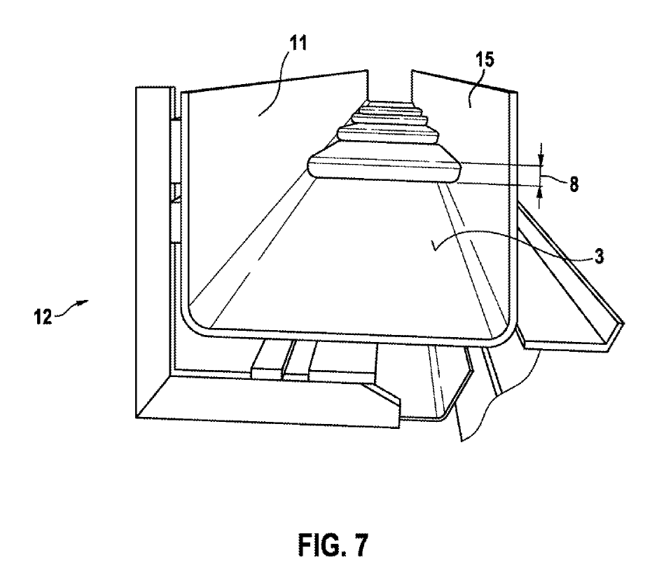

FIG. 7 shows a schematic representation of a sixth embodiment of a vibrating trough 1 according to the invention for transporting shingled products 2. The sixth embodiment corresponds substantially to the fifth embodiment, however the transporting surface 3 in said embodiment comprises on both sides a guide that is located laterally in relation to the direction of transport 7 which is formed from the first laterally located guide 11 and from a second laterally located guide 15. The second laterally located guide 15 extends along the transporting surface 3 from the starting point A up to the end point E and is located on the oppositely situated side of the transporting surface 3 with reference to the first laterally located guide 11. In this case, the second laterally located guide 15 forms a right angle with the floor area 5. The first laterally located guide 11, the second laterally located guide 15 and the transporting surface 3 are formed by a one-piece element. This is achieved in said sixth embodiment as a result of correspondingly reshaping a metal sheet, here by bending it at right angles, said metal sheet also forming the level portions 9. In the previously described embodiments, the first laterally located guide 11 and the second laterally located guide 15 could, however, also be formed, for example, as a separate component or integrally on the transporting surface 3. Even when this is not shown in the figures, such a guide that is located on both sides can also be arranged in the other embodiments. In said sixth embodiment, the transporting surface 3 of the vibrating trough is, in this case, at an angle of 0° degrees in relation to the horizontal 13.

Along with the above written disclosure, reference is explicitly made to FIGS. 1 to 7.

1. A vibrating trough (1) for transporting shingled products (2), said vibrating trough including:
a transporting surface (3) configured to carry the products (2) and to be activated to produce a vibration in order to transport the products (2) along the transporting surface (3) from a starting point (A) to an end point (E) of the transporting surface (3), wherein the transporting surface (3) comprises wedge-shaped portions (4) which are arranged on a floor area (5) of the vibrating trough (1), wherein the wedge-shaped portions (4) comprise in each case:
an ascending region (4a) on a side oriented toward the starting point (A), by means of which the products (2) are raised in relation to the floor area (5) during transport, and
a descending region (4b) on a side oriented toward the end point (E), at which the products (2) fall back onto a lower-lying point of the transporting surface (3) during transport.

2. The vibrating trough (1) as claimed in claim 1, characterized in that the wedge-shaped portions (4) are formed by several overlapping individual elements (6).

3. The vibrating trough (1) as claimed in claim 1, characterized in that the wedge-shaped portions (4) connect directly to one another.

4. The vibrating trough (1) as claimed in claim 1, characterized in that a spacing (14) between two descending regions (4b) of two of the wedge-shaped portions (4) following one after another in the a direction of transport depends on a length L of the product (2).

5. The vibrating trough (1) as claimed in claim 1, characterized in that a spacing (14) between two descending regions (4b) of two of the wedge-shaped portions (4) following one after another in the a direction of transport is within a range of between 100 mm and 1000 mm.

6. The vibrating trough (1) as claimed in claim 1, characterized in that the products (2) fall back in a direction of the floor area (5) at the descending region (4b) during transport.

7. The vibrating trough (1) as claimed in claim 1, characterized in that on at least one side, the transporting surface (3) comprises a guide (11, 15) which is located laterally in relation to a direction of transport (7).

8. The vibrating trough (1) as claimed in claim 7, characterized in that the transporting surface (3) and the laterally located guide (11, 15) are formed by a one-piece element.

9. The vibrating trough (1) as claimed in claim 1, characterized in that the wedge-shaped portions (4) comprise a maximum height (8) which is greater than or equal to a product height (10) of the product (2) to be transported when said product is located on the transporting surface (3).

10. The vibrating trough (1) as claimed in claim 1, characterized in that an angle (α) between the floor area (5) and the ascending region (4a) of two of the wedge-shaped portions (4) increases between two wedge-shaped portions (4) following one after another in a direction of transport.

11. The vibrating trough (1) as claimed in claim 1, characterized in that the floor area (5) forms a plane.

12. A vibratory conveying device, including a vibrating trough (1) as claimed in claim 1, wherein the starting point (A) of the transporting surface (3) is located higher than the end point (E) of the transporting surface (3).

13. The vibratory conveying device, including a vibrating trough (1) as claimed in claim 1, characterized in that the transporting surface (3) of the vibrating trough (1) is inclined laterally in a direction of transport.

14. The vibrating trough (1) as claimed in claim 1, characterized in that a spacing (14) between two descending regions (4b) of two of the wedge-shaped portions (4) following one after another in a direction of transport depends on a length L of the product (2) and is produced by multiplying the length L of the product (2) by a factor of between 1 and 20.

15. The vibrating trough (1) as claimed in claim 1, characterized in that on both sides, the transporting surface (3) comprises a guide (11, 15) which is located laterally in relation to a direction of transport (7).

16. The vibrating trough (1) as claimed in claim 1, characterized in that a rear portion of the floor area (5) located on the side of the end point (E) is raised in relation to its initial development in a direction of the transporting surface (3).

17. A vibratory conveying device, including a vibrating trough (1) as claimed in claim 1, wherein the starting point (A) of the transporting surface (3) is located lower than the end point (E) of the transporting surface (3).
